(19) United States
(12) Patent Application Publication
(10) Pub. No.: US 2026/0303314 A1
(43) Pub. Date: Oct. 1, 2026

(54) TRANSMISSION OCCASION DETERMINATION IN SUB-BAND FULL DUPLEX OPERATION

(71) Applicant: Nokia Technologies Oy, Espoo (FI)

(72) Inventors: Nhat-Quang NHAN, Massy (FR); Jingyuan SUN, Beijing (CN); Youngsoo YUK, Seoul (KR); Erika PORTELA LOPES DE ALMEIDA, Aalborg (DK)

(21) Appl. No.: 19/473,647

(22) PCT Filed: Apr. 17, 2023
(86) PCT No.: PCT/CN2023/088759

§ 371 Date: Oct. 8, 2025

(51) Int. Cl. H04L 5/14; H04L 5/00

(52) U.S. Cl. CPC H04L 5/1438; H04L 5/0044

(57) ABSTRACT

Example embodiments of the present disclosure provide a solution for transmission occasion (TO) determination in a sub-band full duplex (SBFD) operation. In an example method, a terminal device receives scheduling information indicative of a TO spanning across at least one SBFD symbol and at least one non-SBFD symbol in a slot. The terminal device selects, based on determining that the TO is valid, time-domain resources for at least one portion of the TO such that the at least one portion does not span across the at least one SBFD symbol and at least one non-SBFD symbol. The terminal device then transmits or receives data on the at least one portion of the TO according to the selection. In this way, UE and network behaviors for time domain resource allocation determination for the transmission/repetition that spans across SBFD and non-SBFD symbols are defined in case that such transmission is not allowed.

### FIELD

Example embodiments of the present disclosure generally relate to the field of communication, and in particular, to a terminal device, a network device, methods, apparatuses, and a computer readable medium for transmission occasion (TO) determination in a sub-band full duplex (SBFD) operation.

### BACKGROUND

3GPP has agreed to initiate a Rel-18 study item (RP-213591) on the evolution of duplexing operation in new radio (NR). That is to say, downlink (DL) and uplink (UL) transmissions are allowed on different physical resource blocks (PRBs)/sub-bands within an unpaired wideband NR cell, and this is referred to as sub-band full duplex (SBFD). In SBFD operation, there are two symbol types for both DL and UL transmissions, namely: SBFD symbols, during which the non-overlapping DL sub-band(s) and UL subband(s) both exist, and non-SBFD symbols, during which the entire band is used for either DL or UL.

3GPP also agreed to study whether not a slot can consist of both SBFD and non-SBFD symbols. Behaviors of UEs and networks on such slot type have not been investigated yet.

### SUMMARY

In general, example embodiments of the present disclosure provide solutions for TO determination in an SBFD operation.

In a first aspect, there is provided a terminal device. The terminal device comprises at least one processor and at least one memory storing instructions that, when executed by the at least one processor, cause the terminal device at least to: receive, from a network device, scheduling information indicative of a transmission occasion (TO) spanning across at least one sub-band full duplex (SBFD) symbol and at least one non-SBFD symbol in a slot; based on determining that the TO is valid, select time-domain resources for at least one portion of the TO such that the at least one portion does not span across the at least one SBFD symbol and at least one non-SBFD symbol; and transmit or receive data on the at least one portion of the TO according to the selection.

In a second aspect, there is provided a network device. The network device comprises at least one processor and at least one memory storing instructions that, when executed by the at least one processor, cause the network device at least to: transmit, to a terminal device, scheduling information indicative of a transmission occasion (TO) spanning across at least one sub-band full duplex (SBFD) symbol and at least one non-SBFD symbol in a slot; based on determining that the TO is valid, select time-domain resources for at least one portion of the TO such that the at least one portion does not span across the at least one SBFD symbol and at least one non-SBFD symbol; and transmit or receive data on the at least one portion of the TO according to the selection.

In a third aspect, there is provided a method. The method comprises: receiving, from a network device, scheduling information indicative of a transmission occasion (TO) spanning across at least one sub-band full duplex (SBFD) symbol and at least one non-SBFD symbol in a slot; selecting, based on determining that the TO is valid, time-domain resources for at least one portion of the TO such that the at least one portion does not span across the at least one SBFD symbol and at least one non-SBFD symbol; and transmitting or receiving data on the at least one portion of the TO according to the selection.

In a fourth aspect, there is provided a method. The method comprises: transmitting, to a terminal device, scheduling information indicative of a transmission occasion (TO) spanning across at least one sub-band full duplex (SBFD) symbol and at least one non-SBFD symbol in a slot; selecting, based on determining that the TO is valid, time-domain resources for at least one portion of the TO such that the at least one portion does not span across the at least one SBFD symbol and at least one non-SBFD symbol; and transmitting or receiving data on the at least one portion of the TO according to the selection.

In a fifth aspect, there is provided an apparatus. The apparatus comprises: means for receiving, from a network device, scheduling information indicative of a transmission occasion (TO) spanning across at least one sub-band full duplex (SBFD) symbol and at least one non-SBFD symbol in a slot; means for selecting, based on determining that the TO is valid, time-domain resources for at least one portion of the TO such that the at least one portion does not span across the at least one SBFD symbol and at least one non-SBFD symbol; and means for transmitting or receiving data on the at least one portion of the TO according to the selection.

In a sixth aspect, there is provided an apparatus. The apparatus comprises: means for transmitting, to a terminal device, scheduling information indicative of a transmission occasion (TO) spanning across at least one sub-band full duplex (SBFD) symbol and at least one non-SBFD symbol in a slot; means for selecting, based on determining that the TO is valid, time-domain resources for at least one portion of the TO such that the at least one portion does not span across the at least one SBFD symbol and at least one non-SBFD symbol; and means for transmitting or receiving data on the at least one portion of the TO according to the selection.

In a seventh aspect, there is provided a non-transitory computer-readable storage medium comprising program instructions. The program instructions, when executed by an apparatus, cause the apparatus to perform at least the following: receiving, from a network device, scheduling information indicative of a transmission occasion (TO) spanning across at least one sub-band full duplex (SBFD) symbol and at least one non-SBFD symbol in a slot; selecting, based on determining that the TO is valid, time-domain resources for at least one portion of the TO such that the at least one portion does not span across the at least one SBFD symbol and at least one non-SBFD symbol; and transmitting or receiving data on the at least one portion of the TO according to the selection.

In an eighth aspect, there is provided a non-transitory computer-readable storage medium comprising program instructions. The program instructions, when executed by an apparatus, cause the apparatus to perform at least the following: transmitting, to a terminal device, scheduling information indicative of a transmission occasion (TO) spanning across at least one sub-band full duplex (SBFD) symbol and at least one non-SBFD symbol in a slot; selecting, based on determining that the TO is valid, time-domain resources for at least one portion of the TO such that the at least one portion does not span across the at least one SBFD symbol and at least one non-SBFD symbol; and transmitting or receiving data on the at least one portion of the TO according to the selection.

In a ninth aspect, there is provided a computer program comprising instructions, which, when executed by an apparatus, cause the apparatus at least to: receive, from a network device, scheduling information indicative of a transmission occasion (TO) spanning across at least one sub-band full duplex (SBFD) symbol and at least one non-SBFD symbol in a slot; based on determining that the TO is valid, select time-domain resources for at least one portion of the TO such that the at least one portion does not span across the at least one SBFD symbol and at least one non-SBFD symbol; and transmit or receive data on the at least one portion of the TO according to the selection.

In a tenth aspect, there is provided a computer program comprising instructions, which, when executed by an apparatus, cause the apparatus at least to: transmit, to a terminal device, scheduling information indicative of a transmission occasion (TO) spanning across at least one sub-band full duplex (SBFD) symbol and at least one non-SBFD symbol in a slot; based on determining that the TO is valid, select time-domain resources for at least one portion of the TO such that the at least one portion does not span across the at least one SBFD symbol and at least one non-SBFD symbol; and transmit or receive data on the at least one portion of the TO according to the selection.

In an eleventh aspect, there is provided a terminal device. The terminal device comprises: a receiving circuitry configured to receive, from a network device, scheduling information indicative of a transmission occasion (TO) spanning across at least one sub-band full duplex (SBFD) symbol and at least one non-SBFD symbol in a slot; a selecting circuitry configured to select, based on determining that the TO is valid, time-domain resources for at least one portion of the TO such that the at least one portion does not span across the at least one SBFD symbol and at least one non-SBFD symbol; and a transmitting/receiving circuitry configured to transmit or receive data on the at least one portion of the TO according to the selection.

In a twelfth aspect, there is provided a network device. The network device comprises: a transmitting circuitry configured to transmit, to a terminal device, scheduling information indicative of a transmission occasion (TO) spanning across at least one sub-band full duplex (SBFD) symbol and at least one non-SBFD symbol in a slot; a selecting circuitry configured to select, based on determining that the TO is valid, time-domain resources for at least one portion of the TO such that the at least one portion does not span across the at least one SBFD symbol and at least one non-SBFD symbol; and a transmitting/receiving circuitry configured to transmit or receive data on the at least one portion of the TO according to the selection.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1A illustrates an example communication network in which embodiments of the present disclosure may be implemented;

FIG. 1B illustrates an example of physical uplink shared channel (PUSCH) repetition type A in Rel-15;

FIG. 1C illustrates bit selection for PUSCH repetition type A with redundancy version (RV) cycling;

FIG. 1D illustrates an example of PUSCH repetition type A in Rel-17;

FIG. 1E illustrates power spectral density gain offered by transport block processing over multiple slots (TBoMS) compared to single-slot PUSCH for the same transport block size (TBS);

FIG. 1F illustrates an example of time domain resource allocation for TBoMS;

FIG. 1G illustrates bit selection for a single TBoMS transmission;

FIG. 1H illustrates an example of TBoMS repetition;

FIG. 1I illustrates frequency-time resource partitioning with SBFD as compared to traditional FDD and TDD;

FIG. 1J illustrates an example of SBFD and non-SBFD slots;

FIG. 1K illustrates co-channel interference types in SBFD deployment;

FIG. 1L illustrates an example of SBFD and non SBFD symbols in special slot;

FIG. 1M illustrates an example of PUSCH repetitions in SBFD starting from a full UL slot;

FIG. 2 illustrates an example of a process flow in accordance with some example embodiments of the present disclosure;

FIG. 3 illustrates an example of UL transmission occasion in a mixed slot;

FIG. 4 illustrates another example of a process flow in accordance with some example embodiments of the present disclosure;

FIG. 5 illustrates a flowchart of an example method implemented at a terminal device in accordance with some embodiments of the present disclosure;

FIG. 6 illustrates another flowchart of an example method implemented at a network device in accordance with some embodiments of the present disclosure;

FIG. 7 illustrates a simplified block diagram of a device that is suitable for implementing some example embodiments of the present disclosure; and

FIG. 8 illustrates a block diagram of an example of a computer-readable medium in accordance with some example embodiments of the present disclosure.

Throughout the drawings, the same or similar reference numerals represent the same or similar elements.

### DETAILED DESCRIPTION

Principles of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “network”, “communication network” or “data network” refers to a network following any suitable communication standards, such as long term evolution (LTE), LTE-advanced (LTE-A), wideband code division multiple access (WCDMA), high-speed packet access (HSPA), narrow band Internet of things (NB-IoT), wireless fidelity (Wi-Fi) and so on. Furthermore, the communications between a terminal device and a network device/element in the communication network may be performed according to any suitable generation communication protocols, including, but not limited to, the fourth generation (4G), 4.5G, the future fifth generation (5G), IEEE 802.11 communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP) or a transmission and reception point (TRP), for example, a node B (NodeB or NB), an evolved NodeB (eNodeB or eNB), a NR NB (also referred to as a gNB), a remote radio unit (RRU), a radio header (RH), a remote radio head (RRH), a WiFi device, a relay, a low power node such as a femto, a pico, and so forth, depending on the applied terminology and technology. In the following description, the terms “network device”, “AP device”, “AP” and “access point” may be used interchangeably.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), a station (STA) or station device, or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IOT) device, a watch or other wearable, a head-mounted display (HMD), a vehicle, a drone, a medical device and applications (for example, remote surgery), an industrial device and applications (for example, a robot and/or other wireless devices operating in an industrial and/or an automated processing chain contexts), a consumer electronics device, a device operating on commercial and/or industrial wireless networks, and the like. In the following description, the terms “station”, “station device”, “STA”, “terminal device”, “communication device”, “terminal”, “user equipment” and “UE” may be used interchangeably.

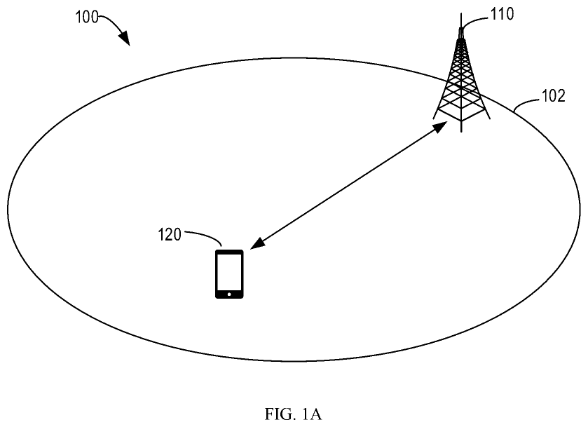

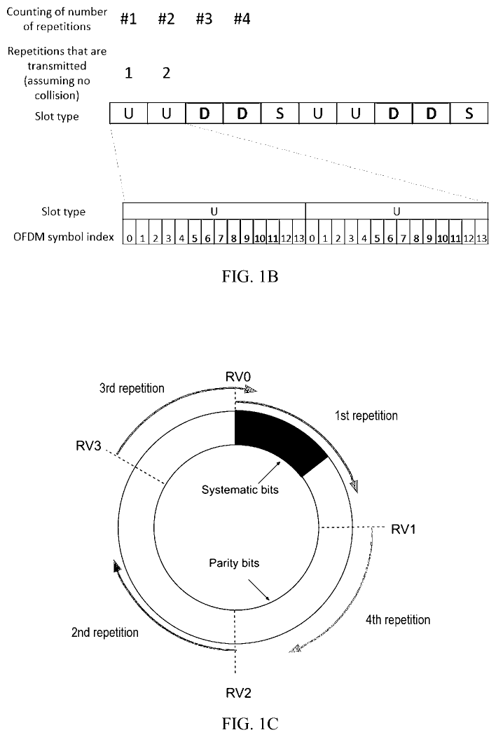

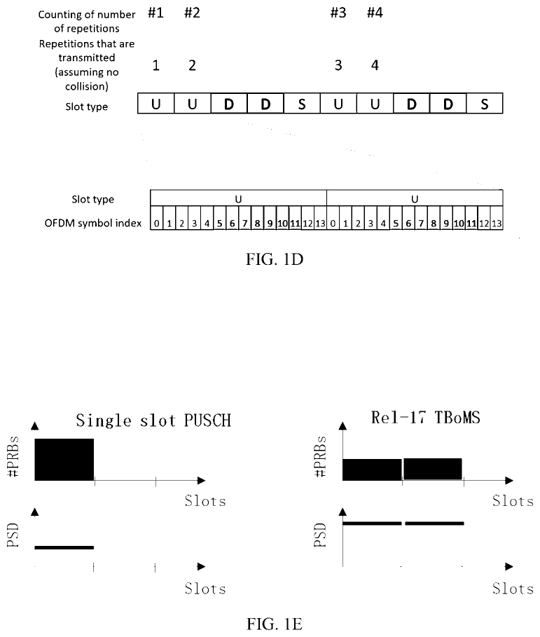

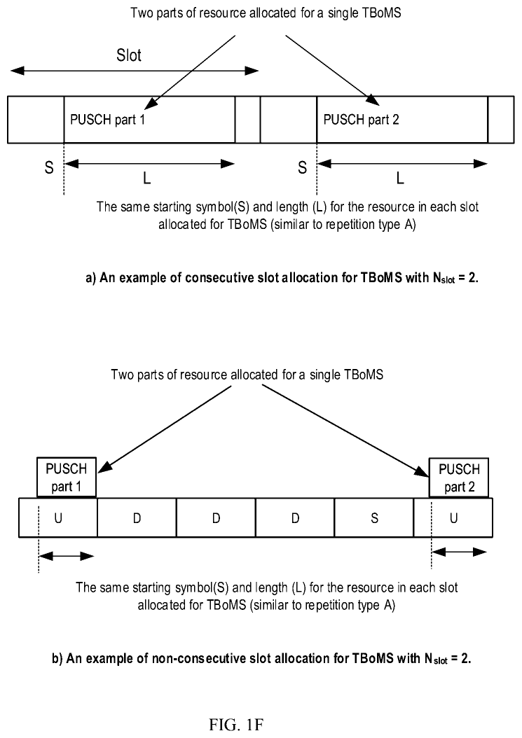

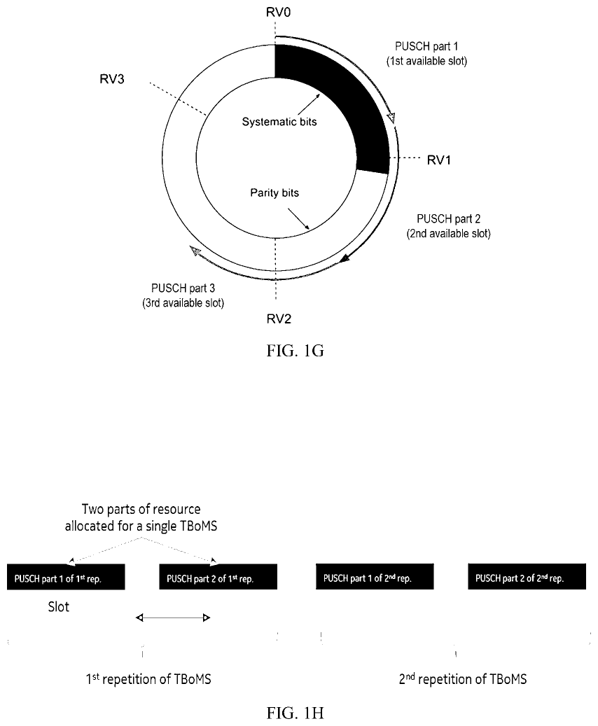

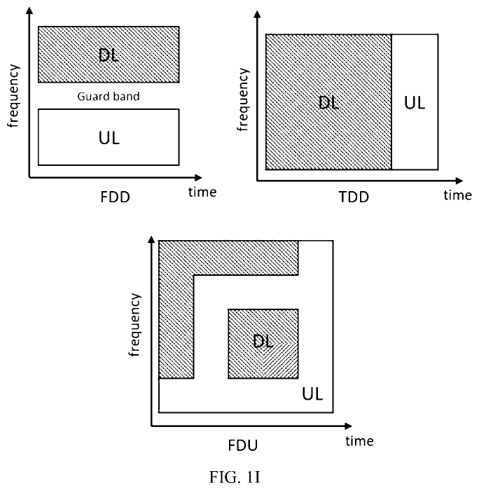

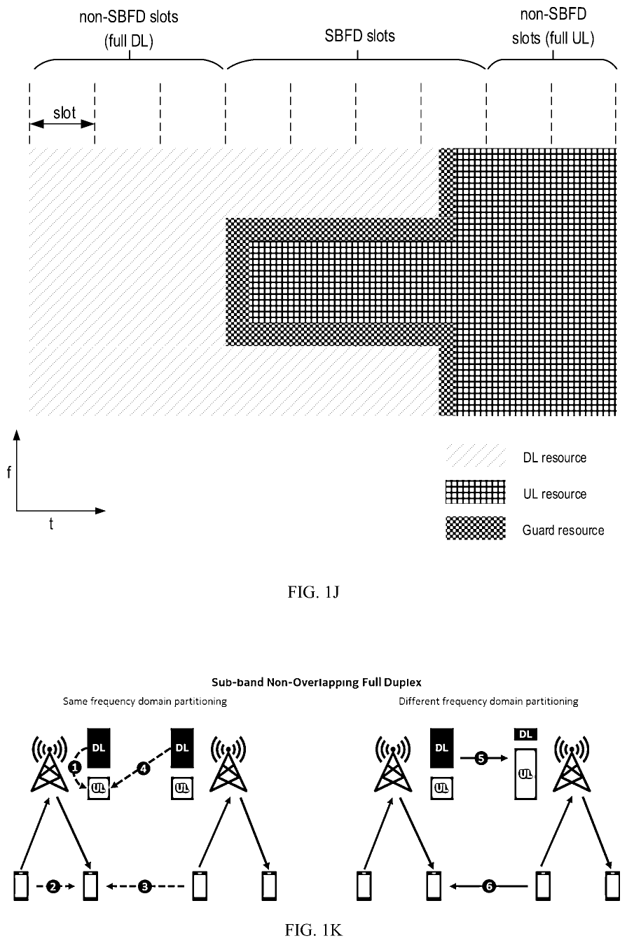

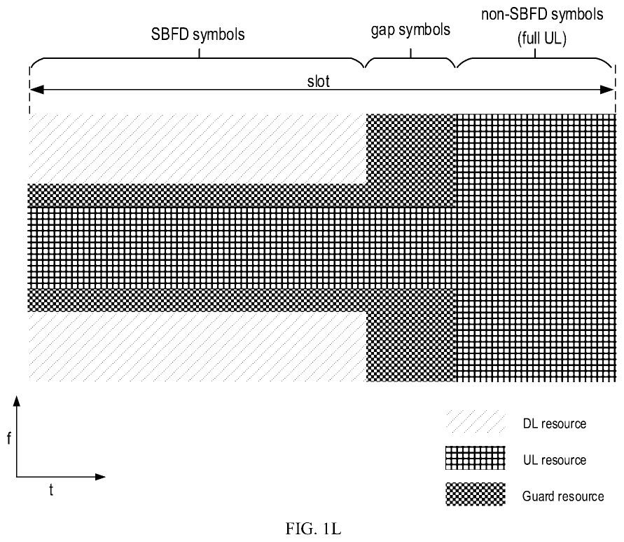

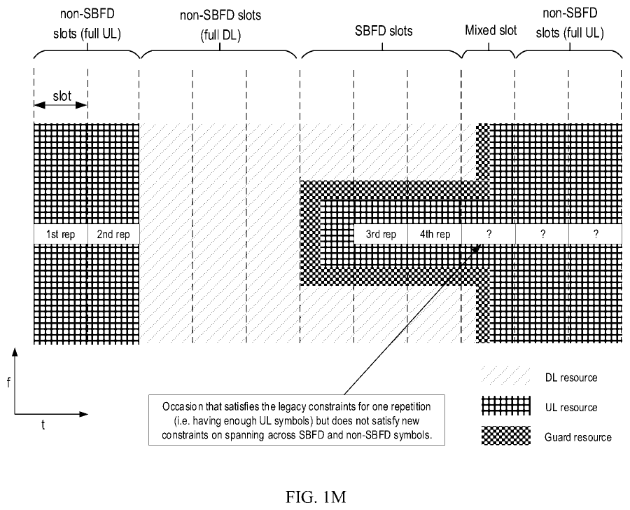

For illustrative purposes, principle and example embodiments of the present disclosure will be described below with reference to FIG. 1A to FIG. 8. However, it is to be noted that these embodiments are given to enable the skilled in the art to understand inventive concepts of the present disclosure and implement the solution as proposed herein, and not intended to limit scope of the present application in any way.

FIG. 1A illustrates an example of an application scenario 100 in which some example embodiments of the present disclosure may be implemented. The application scenario 100, which is a part of a communication network, includes terminal devices and network devices.

In the descriptions of the example embodiments of the present disclosure, the network environment 100 may also be referred to as a communication system 100 (for example, a portion of a communication network). For illustrative purposes only, various aspects of example embodiments will be described in the context of one or more terminal devices and network devices that communicate with one another. It should be appreciated, however, that the description herein may be applicable to other types of apparatus or other similar apparatuses that are referenced using other terminology.

As illustrated in FIG. 1A, the communication network 100 may include a network device 110 (which may also be referred to as a gNB or BS). The communication network 100 may further include a terminal device 120 (which may also be referred to as user equipment 120 or UE 120. Although only one network device 110 and one terminal devices 120 are shown in FIG. 1A, the numbers of the network device and the terminal device are not limited. In other words, there may be one or more network devices 110 and one or more terminal devices 120 in the network.

The network device 110 can provide services to the terminal device 120, and the network device 110 and the terminal device 120 may communicate data and control information with each other. In some embodiments, the network device 110 and the terminal device 120 may communicate with direct links/channels.

In the communication system 100, a link from the network device 110 to the terminal device 120 is referred to as a downlink (DL), while a link from the terminal device 120 to the network device 110 is referred to as an uplink (UL). In downlink, the network device 110 is a transmitting (TX) device (or a transmitter) and the terminal device 120 is a receiving (RX) device (or a receiver). In uplink, the terminal device 120 is a transmitting (TX) device (or a transmitter) and the network device 110 is a RX device (or a receiver). It is to be understood that the network device 110 may provide one or more serving cells. As illustrated in FIG. 1A, the network device 110 provides one serving cell 102, and the terminal device 120 camps on the serving cell 102. In some embodiments, the network device 110 can provide multiple serving cells and the terminal device 120 may switch from a source cell to a target cell between the serving cells during its mobility. It is to be understood that the number of serving cell(s) shown in FIG. 1A is for illustrative purposes without suggesting any limitation.

Communications in the network environment 100 may be implemented according to any proper communication protocol(s), comprising, but not limited to, cellular communication protocols of the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

It is to be understood that the number of devices and their connection relationships and types shown in FIG. 1A are for illustrative purposes without suggesting any limitation. The communication system 100 may comprise any suitable number of devices adapted for implementing embodiments of the present disclosure.

Rel-15 introduces a slot aggregation feature for physical uplink shared channel (PUSCH), which is also known as PUSCH repetition type A. In this feature, transmission of a transport block is repeated in multiple slots. The following key design aspects of PUSCH repetition type A in Rel-15 can be noted:
Resource allocation: The same resource allocation is applied across the PUSCH repetitions.
   Time domain: Each repetition is in a slot. Only a single starting and length of a PUSCH within a slot is indicated, i.e., a single start and length indicator value (SLIV). The same start and length indicated by the single SLIV is applied across all PUSCH repetitions. In Rel-15, the number of repetitions for PUSCH repetitions type A is semi-statically configured in RRC and the number of repetitions is counted on consecutive physical slots, as illustrated in FIG. 1B, which illustrates an example of PUSCH repetition type A in Rel-15 with 4 repetitions, S=5 and L=7, assuming DDSUU (10D: 2G: 2U) TDD pattern.
   If the number of available symbols in a slot is not sufficient (<L), PUSCH repetition is not transmitted in the slot.
   Frequency domain: The PUSCH repetitions have the same frequency domain resource allocation (i.e., the same number of physical resource blocks (PRBs) and maybe the same location of these PRBs in frequency domain if frequency hopping is not enabled).
Transport block size (TBS) determination: NInfo for PUSCH repetition type A is calculated based on the number of REs determined in a slot.
Rate-matching: The same or different redundancy version (RV) of the encoded bits in circular buffer can be applied for each PUSCH repetition. RV for the first repetition can be indicated by scheduling DCI for dynamic grant or preconfigured for configured grant. If different RVs are applied, RVs are cycled from a configured RV sequence, following the indicated RV for the first repetition. There are four RVs, each provides information on the starting encoded bit from circular buffer that UE should map to a PUSCH transmission associated with the RV, as illustrated in FIG. 1C, which illustrates bit selection for PUSCH repetition type A with RV cycling.

Rel-16 allows to dynamically indicate number of repetitions for PUSCH repetition type A by associating the number of repetitions to each row of time domain resource assignment (TDRA) table. Furthermore, Rel-16 also introduces PUSCH repetition type B for ultra-reliable low latency (URLLC) applications. In this feature, single SLIV is used for determining multiple back-to-back nominal repetitions with the same length and each nominal repetition can span across the slot boundary. Then, each nominal repetition is split into multiple actual repetitions if it crosses the slots boundary or invalid symbols. The PUSCH repetitions in PUSCH repetition type B also have the same frequency domain resource allocation. Note that this type of PUSCH repetitions is only added for completeness.

Rel-17 further improves PUSCH repetition type A by allowing the number of repetitions to be counted on available slots, i.e., only on the slots that are available for the transmissions of the repetitions as illustrated in FIG. 1D which illustrates an example of PUSCH repetition type A in Rel-17 with 4 repetitions, S=5 and L=7, assuming DDSUU (10D: 2G: 2U) TDD pattern. Rel-17 also increases the maximum number of repetitions from 16 to 32 for PUSCH repetition type A.

Rel-17 coverage enhancement WI specifies a feature called transport block processing over multiple slots (TBoMS). This feature allows mapping a single transport block (TB) over multiple slots, i.e., resource allocation for a single PUSCH transmission can span across multiple slots. This is different from PUSCH repetitions.

FIG. 1E illustrates power spectral density gain offered by transport block processing over multiple slots (TBoMS) compared to single-slot PUSCH for the same transport block size (TBS). As illustrated in FIG. 1E, one main advantage of TBoMS is that it can reduce the number of PRBs needed for transmitting the same transport block size (TBS) compared to the case when the TB is transmitted in a single slot. This helps increasing the energy per resource element (EPRE). Therefore, improving the coverage.

Some key design aspects of TBoMS can be summarized as follows:
Resource allocation:
   Time domain: A new column is added in TDRA table for indicating the number of slots allocated for TBoMS (Nₛₗₒₜ). Nₛₗₒₜ is counted on available slots (following Rel-17 rules of counting on available slots for PUSCH repetition type A). Hence, non-consecutive slots can be used for TBoMS in TDD. The same starting symbol(S) and length (L) for the resource in each slot allocated for TBoMS (similar to repetition type A), as shown in FIG. 1F which illustrates an example of time domain resource allocation for TBoMS with Nₛₗₒₜ=2.
   Frequency domain: The same number of PRBs is allocated across slots for TBoMS transmission (similar to repetition type A).
TBS determination: N_{Info} for TBoMS is calculated based on the number of REs determined in the first slot allocated for TBOMS scaled by Nₛₗₒₜ, where Nₛₗₒₜ is the number of slots allocated for TBoMS. In other words, the TBS for TBoMS is calculated based on the total resource allocated for TBoMS across multiple slots.
Rate-matching:
   Only a single redundancy version is used for a single TBoMS (i.e., no RV cycling within a single TBoMS).
   Bit selection from circular buffer and bit interleaving are performed per slot.
   For bit selection in a slot, the index of the starting coded bit in the circular buffer is the index continuous from the position of the last bit selected in the previous allocated slot, regardless of whether UCI multiplexing occurred in the previous allocated slot or not, as shown in FIG. 1G which illustrates bit selection for a single TBoMS transmission with Nₛₗₒₜ=3.
   TBoMS transmission is limited to one code block only.
Repetition of a single TBoMS:
   Repetitions of a single TBoMS is supported.
   The column in TDRA table that indicates number of repetitions for Rel-17 PUSCH repetition type A (i.e., numberOfRepetitions-r17) is used for indicating also the number of repetitions of a single TBoMS (Nᵣₑₚ).
   The UE determines Nᵣₑₚ*Nₛₗₒₜ available slots for TBoMS repetition, same S & L on each slot, but TBS will be calculated by the resource of a single TBoMS (i.e., scaled by Nₛₗₒₜ). FIG. 1H illustrates an example of TBoMS repetition with Nₛₗₒₜ=2 & Nᵣₑₚ=2.
   Redundancy versions (RVs) are cycled across the TBoMS repetitions. The legacy Rel-15/16 RV sequences and RV index indication are reused.

Rel-18 study item on duplexing evolution, including subband non-overlapping full duplex (SBFD). 3GPP 5G NR currently supports two duplexing modes: FDD for paired bands and TDD for unpaired bands. In TDD, the time domain resource is split between downlink and uplink. Allocation of a limited time duration for the uplink in TDD would result in reduced coverage, increased latency, and reduced capacity.

Motivated by this, 3GPP has agreed to initiate a Rel-18 study item (RP-213591) on the evolution of duplexing operation in NR that addresses the challenges above. One of the objectives of the study item is to allow simultaneous DL and UL transmission on different physical resource blocks (PRBs)/subbands within an unpaired wideband NR cell, as illustrated in FIG. 1I which illustrates frequency-time resource partitioning with SBFD as compared to traditional FDD and TDD. In this disclosure, it is also referred as subband non-overlapping full duplex (SBFD). In other sources, this duplexing scheme is also referred to as cross division duplexing (xDD) scheme or flexible division duplexing (FDU).

Below are some of the most relevant objectives of the study item (RP-213591) in the study item description with regards to this disclosure.

In this study, the followings are assumed:

| | |
|---|---|
| • | Duplex enhancement at the gNB side |
| • | Half duplex operation at the UE side |
| • | No restriction on frequency ranges |

The detailed objectives are as follows:

| • | ( . . . ) | |
|---|---|---|
| • | Study the subband non-overlapping full duplex and potential enhancements on | |
| | dynamic/flexible TDD (RAN1, RAN4). | |
| | - | Identify possible schemes and evaluate their feasibility and performances (RAN1). |
| | - | Study inter-gNB and inter-UE CLI handling and identify solutions to manage them |
| | | (RAN1). |

| | |
|---|---|
| [symbol] | Consider intra-subband CLI and inter-subband CLI in case of the subband |
| | non-overlapping full duplex. |

| | |
|---|---|
| - | Study the performance of the identified schemes as well as the impact on legacy operation |
| | assuming their co-existence in co-channel and adjacent channels (RAN1). |
| - | Study the feasibility of and impact on RF requirements considering adjacent-channel |
| | co-existence with the legacy operation (RAN4). |
| - | Study the feasibility of and impact on RF requirements considering the self-interference, |
| | the inter-subband CLI, and the inter-operator CLI at gNB and the inter-subband CLI and |
| | inter-operator CLI at UE (RAN4). |
| - | ( . . . ) |

Below are examples of definitions of SBFD slots. FIG. 1J illustrates an example of SBFD and non-SBFD slots. From the above description of SBFD operation, it can be observed that there are two slot types for both DL and UL transmissions as shown in FIG. 1J, namely:
SBFD slots, during which the non-overlapping DL subbands and UL subband(s) both exist, and
Non-SBFD slots, during which the entire band is used for either DL or UL (i.e., legacy/full DL/UL slots).

Several SBFD operation modes have been studied including whether time and frequency locations of subbands for SBFD operation are known to the SBFD-aware UE or not. It however has been agreed in 3GPP RAN1 #110 meeting that at least the operation mode with time and frequency locations of subbands for SBFD operation being known to the SBFD-aware UE is prioritized. This means that SBFD slots should be known by the (SBFD-aware) UE in one way or another.

It is noted that there are Cross-link interferences (CLIs) on the SBFD slots. As explained in Nokia's Tdoc for RAN1 #110 meeting (R1-2207267) and illustrated in FIG. 1K, SBFD introduces a new CLI type, namely co-channel inter-subband CLI. This interference can be better classified as
1. gNB self-interference.
2. intra-cell UE-to-UE co-channel inter-subband CLI.
3. inter-cell UE-to-UE co-channel inter-subband CLI.
4. gNB-to-gNB co-channel inter-subband CLI.

Besides these new CLI types, in case of different frequency domain partitioning in neighbor cells, the system may also suffer from co-channel intra-subband CLI, i.e. CLI from transmissions on overlapping frequency resources:
5. gNB-to-gNB inter-cell co-channel intra-subband CLI.
6. UE-to-UE inter-cell co-channel intra-subband CLI.

One design aspect that should be considered for SBFD operation is whether a slot can consist of both SBFD and non-SBFD symbols or not. Another design aspect for SBFD operation could be whether a transmission can span across SBFD and non-SBFD symbols or not, including
a) a transmission that spans across multiple slots, each slot consist of symbols with a same symbol type and symbol types may be different from one slot to another from the multiple slots (e.g., PUSCH repetitions or TBoMS) and
b) a transmission that spans across SBFD symbol and non-SBFD symbol within a slot (e.g., a single PUSCH or a PUSCH repetition).

In this regard, the following can be observed:
Given that one of the main motivations of introducing SBFD operation is for UL coverage enhancement (offering more UL resources) whereas PUSCH repetitions/TBoMS are basic features to be used in coverage shortage, therefore, the scenario wherein the PUSCH repetitions/TBoMS spans across SBFD and non-SBFD slots should be supported.
In addition, it is straightforward to observe that a slot consisting of both SBFD and non-SBFD symbols should be supported at least for the (legacy) special slot, which consists of DL, gap, and UL symbols, as shown in FIG. 1L.

Although it is straightforward from above observations that a slot can consist of both SBFD and non-SBFD symbols, however 3GPP radio access network (RAN) working group (WG) 1, i.e. RAN1, is still discussing whether a transmission within the slot can span across both SBFD and non-SBFD symbols. Indeed, as discussed R1-2301411, concern is mainly on the current hardware implementation. Specifically,
From NW perspective, switching between SBFD and non-SBFD symbols may require a transition guard period to switch the panels, tune filter and adjust timing which disrupt the transmission or reception (NW may use one panel for UL reception in SBFD symbols while using two panels in the UL symbols).
From UE perspective, SBFD-aware UE may need to do filter retuning and UL sampling rate adjustment from SBFD to UL-SB. For the other example of switching from DL to SBFD, SBFD-ware UE may adjust DL filtering between DL symbol and SBFD symbols which interrupts DL reception.

Therefore, two possibilities may be considered by RAN1, i.e., RAN1 either specifies that a transmission cannot span across SBFD and non-SBFD symbols within a slot or letting NW to configure whether a transmission can span across SBFD and non-SBFD symbols within a slot or not, depending on NW and UE capabilities

However, regardless of which approach is adopted in the end, in case that a transmission cannot span across SBFD and non-SBFD symbols within a slot, then UE behaviour for TDRA determination for the transmission/repetition that spans across SBFD and non-SBFD symbols within a slot should be defined (which is not currently available and will be proposed in this invention).

This is extremely relevant in case of PUSCH or PDSCH with repetitions, given that PUSCH/PDSCH repetitions follows the same resource allocation as allocated for the first repetition, as summarized above. Therefore, consider an example as shown in FIG. 1M which illustrates PUSCH repetitions in SBFD with S=0, L=14, starting from a full UL slot. A PUSCH transmission with repetitions that is scheduled in the entire slot (14 symbols), then UE behaviour for TDRA determination for the repetition in a slot that consists of both SBFD and non-SBFD symbols (referred to as mixed slot hereinafter) is unclear and need to be defined/determined by UE. In addition, in case of PUSCH repetitions counted on available slots (Rel-17 feature as summarized above), whether the mixed slot is counted as an available slot or not should be specified. Embodiments of the disclosure are provided in view of the above analysis and discussion.

Generally, embodiments of the disclosure propose a solution for TDRA determination in case that a transmission occasion (TO) spans across SBFD and non-SBFD symbols in a slot. The TO may refer to a candidate PUSCH/PDSCH repetition within a slot or candidate PUSCH transmission within a slot for TBoMS or any RRC configured resource for PUSCH/PDSCH transmission. In some embodiments, the terminal device 120 receives from the network device 110 scheduling information indicative of a TO spanning across at least one sub-band full duplex (SBFD) symbol and at least one non-SBFD symbol in a slot. The terminal device 120 may determine whether the TO is valid. Herein a TO for an UL transmission is valid when all the resource elements (REs) in the TO are uplink REs and available for the UL transmission, or similarly, a TO for a DL transmission is valid when all the resource elements (REs) in the TO are downlink REs and available for the DL transmission. If the TO is valid, the terminal device 120 selects time-domain resources for at least one portion of the TO such that the at least one portion does not span across the at least one SBFD symbol and at least one non-SBFD symbol, and transmits or receives data on the at least one portion of the TO according to the selection. In some embodiments, the network device 110 may transmit the scheduling information indicative of the TO spanning across the at least one SBFD symbol and the non-SBFD symbol in the slot to the terminal device 120, select time-domain resources and perform transmission or reception correspondingly such that both sides operate on the same resources.

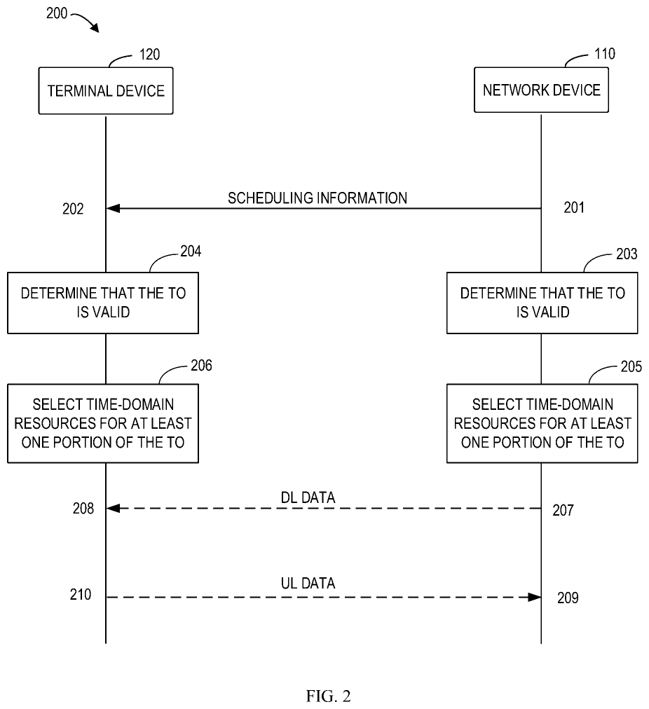

FIG. 2 illustrates an example of a process flow in accordance with some example embodiments of the present disclosure. For ease of understanding, the process flow 400 will be described with reference to FIG. 1A. It would be appreciated that although the process flow 200 has been described referring to the communication network 100 of FIG. 1A, this process flow 200 may be likewise applied to other similar communication scenarios.

As shown in FIG. 2, the network device 110 transmits (201) to the terminal device 120 scheduling information indicative of a transmission occasion (TO) spanning across at least one sub-band full duplex (SBFD) symbol and at least one non-SBFD symbol in a slot. Accordingly, the terminal device 120 receives (202) the scheduling information.

In some embodiments, the TO may be a UL or DL transmission occasion (e.g. for PUSCH or PDSCH). In some embodiments, the TO may be for data repetition, or TBoMS, or RRC configured grant resource. The slot on which the TO is scheduled may consists of both SBFD and non-SBFD symbol(s), and may be referred as a mixed slot.

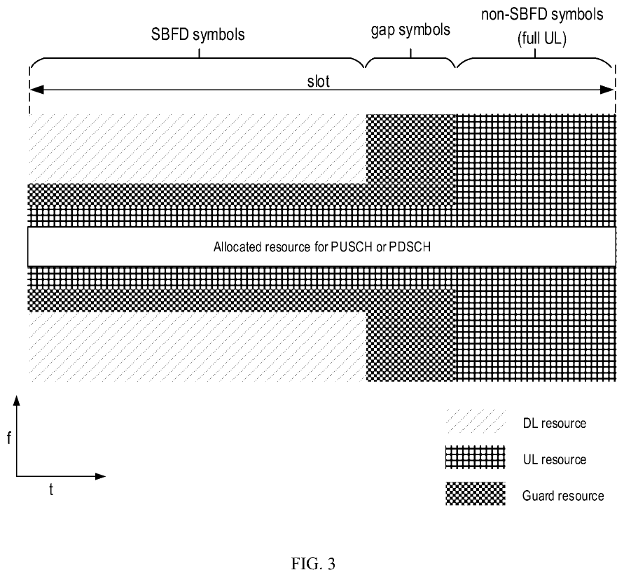

FIG. 3 illustrates an example of a TO in a mixed slot, which consists of SBFD symbols, non-SBFD symbols, and (optionally) gap symbols. As shown, the SBFD symbols may include both of uplink (UL) frequency resources and downlink (DL) frequency resources, and the non-SBFD symbol may include either UL frequency resources or DL frequency resources. The gap symbol(s), if any, may include guard time resources.

It is worth noting that, in some embodiments, no special handling for the portion of TO in the gap symbols is proposed, therefore, only the SBFD and non-SBFD symbols hereinafter are referred for simplicity, with implication that the gap symbols (if there is any) could either be included in SBFD or non-SBFD symbols. Thus, both of the network device 110 and the terminal device 120 may any gap symbol including guard time resources in the slot as a SBFD symbol or a non-SBFD symbol.

Upon receiving (202) the scheduling information, the terminal device 120 determines (204) that the TO is valid. Based on determining (204) that the TO is valid, the terminal device 120 selects (206) time-domain resources for at least one portion of the TO such that the at least one portion does not span across the at least one SBFD symbol and at least one non-SBFD symbol. Correspondingly, the network device 110 also determines (203) that the TO is valid, and based on determining (203) that the TO is valid, selects (205) time-domain resources for at least one portion of the TO such that the at least one portion does not span across the at least one SBFD symbol and at least one non-SBFD symbol. By doing this, the terminal device 120 and the network device 110 may align time resources for data transmission or reception.

The network device 110 transmits (207) data on the at least one portion of the TO according to the selection. Correspondingly, the terminal device 120 receives (208) the data on the at least one portion of the TO according to the selection.

Alternatively or additionally, the terminal device 120 transmits (210) data on the at least one portion of the TO according to the selection. Correspondingly, the network device 110 (209) receives the data the at least one portion of the TO according to the selection.

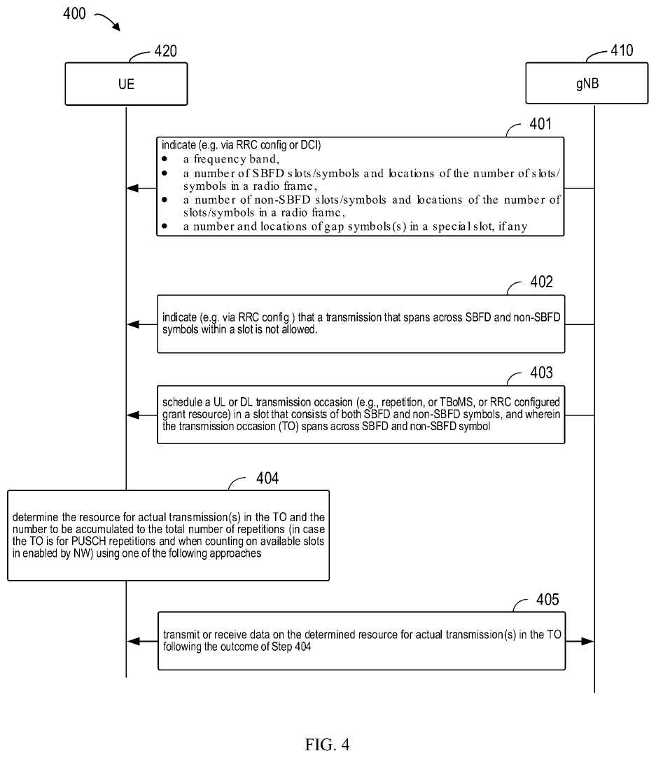

FIG. 4 illustrates another example of a process flow in accordance with some example embodiments of the present disclosure. In FIG. 4, the gNB 410 may be an example implementation of the network device 110, and the UE may be an example implementation of the terminal device in FIG. 1A.

At step 401, the gNB 410 may indicate to the UE 420, and the UE 420 may receive a set of configurations via radio resource control message(s) or downlink control information (DCI).

In some embodiments, the UE 420 may be indicated, for example, a frequency band. Alternatively or additionally, the UE 420 may be indicated a number of slots/symbols wherein the frequency band is split into multiple subbands and wherein at least one subband is used for DL transmissions and at least one subband is used for UL transmissions, i.e., sub-band full duplex (SBFD) slots/symbols, and locations of the number of slots/symbols in a radio frame. The UE 420 may be indicated a number of slots/symbols wherein the entire frequency band is used for DL transmissions or UL transmissions, i.e., non-SBFD slots/symbols, and locations of the number of slots/symbols in a radio frame. Alternatively or additionally, the UE 420 may be indicated a number and locations of gap symbols(s) in a special slot, if any.

At step 402, the gNB 410 may indicate to the UE 420, and the UE 420 may receive (e.g. via RRC) an indication that a transmission that spans across SBFD and non-SBFD symbols within a slot is not allowed. Note that in case it is hard coded in specification that a transmission that spans across SBFD and non-SBFD symbols within a slot is not allowed, this step is not needed. In addition, the order of step 401 and step 402 are interchangeable or mergeable, they are split herein for the sake of clarity.

At step 403, the gNB 410 may transmit scheduling information indicative of a transmission occasion (TO) to the UE 420. The slot may consist of both SBFD and non-SBFD symbol(s). The TO may span across at least one of the SBFD symbols and at least one of the non-SBFD symbol(s) of the mixed slot as shown in FIG. 3. In some embodiments, the TO may be a UL or DL transmission occasion (e.g. for PUSCH or PDSCH). In some embodiments, the TO may be for data repetition, or TBoMS, or RRC configured grant resource.

At step 404, the UE 420 may further determine the resource for actual transmission(s) in the TO and the number to be accumulated to the total number of repetitions (in case that the TO is for PUSCH repetitions and when counting on available slots in enabled by the gNB 410).

At step 405, the UE 420 transmit or receive data on the determined resource for actual transmission(s) in the TO following the outcome of step 404.

At step 404, the UE 420 may firstly determine whether the TO is valid, and then applies different approaches. In some embodiments, a TO for an UL transmission may be determined valid when all the REs in the TO are UL REs and available for the UL transmission, or a TO for a DL transmission may be determined valid when all the REs in the TO are DL REs and available for the DL transmission. Otherwise, the TO may be determined invalid.

When the UE 420 determines that the TO is valid, it may select time-domain resources for at least one portion of the TO such that the at least one portion does not span across the at least one SBFD symbol and at least one non-SBFD symbol. In some embodiments, the UE 420 may determine that the TO is a valid TO and transmits (e.g., rate-matches) or receives data only on the portion of the TO in SBFD symbols or non-SBFD symbols. The at least one portion of the TO may be either a first portion of the TO in the at least one SBFD symbol or a second portion of the TO in the at least one non-SBFD symbol. Accordingly, the UE 420 may transmit or receive data on one of the first portion of the TO or the second portion of the TO, and disable transmission or reception of data on the other one of the first portion of the TO or the second portion of the TO.

In some embodiments, which one of the first portion of the TO and the second portion of the TO is used for transmission or reception may be determined based on a preconfigured configuration. The preconfigured configuration may be hard coded in specification or configured by the gNB 410, e.g. via RRC configuration. In some embodiments, it may be hard coded in specification that the UE 420 always transmits or receives data only on the portion of the TO in SBFD symbols. Alternatively, it may be hard coded in specification that the UE 420 always transmits or receives data only on the portion of the TO in non-SBFD symbols.

In some embodiments, which one of the first portion of the TO and the second portion of the TO is used for transmission or reception may be determined based on the length thereof, e.g. the longer one. The UE 420 may firstly determines the portion of the TO that is longer (having higher number of symbols) between the first portion of the TO in the SBFD symbols and the second portions of the TO in the non-SBFD symbols. The UE 420 may then transmit or receive data only on the determined portion of the TO that is longer.

In some embodiments, in case that the TO is for data repetition (e.g. PUSCH repetition) with a number of repetitions counted on available slots, the UE 420 may count on the slot as one repetition for the data repetition.

Above is the approach where the UE 420 transmits or receives data only on one portion of the TO such that the TO does not span across the SBFD symbols and non-SBFD symbols. Alternatively or additionally, the UE 420 may transmit or receive data on two separate portions of the TO where each portion of the TO does not span across the SBFD symbols and non-SBFD symbols.

In some embodiments, the TO is considered as nominal TO, say a first TO, the UE 420 may determine that the nominal TO is split into two valid actual TOs, say a second TO and a third TO. Nominal here may be understood to exist in name, i.e. the actual TOs are determined on the basis of the nominal TO. One actual TO takes the portion of the nominal TO in SBFD symbols and one actual TO takes the portion of the nominal TO in non-SBFD symbols. The UE 420 then transmits (e.g., rate-matches) or receives data on the two actual TOs. Alternatively or additionally, in case that the TO is for PUSCH repetition and counting on available slots is enabled, the slot is counted as two repetitions.

In some embodiments, when the nominal TO is for data repetition (e.g. for PUSCH), the two actual TOs the two actual TOs may be considered as two repetitions and may use different redundancy versions (RVs) for rate-matching. When the number of repetitions is counted on available slots, the UE 420 may count on the slot as two repetitions for the data repetition because of two data transmissions.

In some embodiments, when the nominal TO is for transport block processing over multiple slots (TBoMS), the two actual TOs are considered as two transmission attempts of the same transport block (TB). The two actual TOs may use a same RV for rate-matching, and the data is rate-matched continuously across the two TOs (similar to what is done for TBoMS across slots).

When selecting the time-resources for the TO, the UE 420 may determine whether a portion of the TO (e.g. in SBFD symbols) overlaps with any other UL or DL transmission (regardless of whether the TO is prioritized or not). If there is overlapping, the UE 420 may transmit or receive data only on the portion of the TO that is not overlapped with the other UL or DL transmission. Otherwise, the above embodiments are applied, that is, the non-overlapping portion is included in the at least one portion of the TO according to the selection such that it satisfies the constraint on not spanning across the SBFD symbols and the non-SBFD symbols.

The embodiments for the valid TO are described above. When the UE 420 determines that the TO is invalid, it does not transmit or receive data on the TO. In some embodiments, it may transmission or reception of data on the invalid TO. In case that the TO is for data repetition with number of repetitions is counted on available slots, the UE 420 may skip counting on the slot.

Although discussions about steps 404 and 405 are made from a perspective of view from the UE 420, it would be appreciated that the same acts are also applicable to the network device 110. Thus, details from a perspective of view from the network device 110 are omitted for brevity.

In view of the above, embodiments of the disclosure define the terminal device and the network device's behaviours for TDRA determination for the transmission/repetition that spans across SBFD and non-SBFD symbols, in case that a transmission cannot span across SBFD and non-SBFD symbols within a slot (regardless of being not supported by hardware implementation, configured by network or fixed by the specification). In some embodiments, PUSCH or PDSCH with repetitions are also enhanced regarding this case.

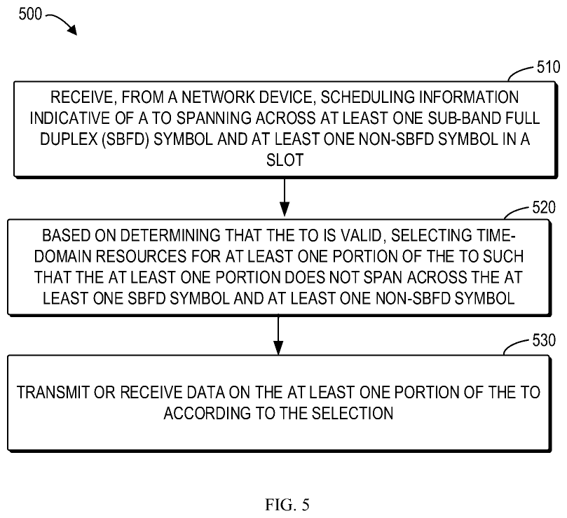

FIG. 5 illustrates a flowchart of an example method 500 implemented at a terminal device in accordance with some other embodiments of the present disclosure. For ease of understanding, the method 500 will be described from the perspective of the terminal device 120 with reference to FIG. 1A.

At block 510, the terminal device 120 receives, from a network device 110, scheduling information indicative of a transmission occasion (TO) spanning across at least one sub-band full duplex (SBFD) symbol and at least one non-SBFD symbol in a slot. In some embodiments, the at least one SBFD symbol may include both of uplink (UL) frequency resources and downlink (DL) frequency resources. The at least one non-SBFD symbol may include either UL frequency resources or DL frequency resources. In some embodiments, the slot may comprise one or more gap symbols including guard time resources. The terminal device 120 may regard the one or more gap symbols as SBFD symbol(s) or non-SBFD symbol(s).

At block 520, based on determining that the TO is valid, the terminal device 120 selects time-domain resources for at least one portion of the TO such that the at least one portion does not span across the at least one SBFD symbol and at least one non-SBFD symbol.

At block 530, the terminal device 120 transmits or receives data on the at least one portion of the TO according to the selection.

In some embodiments, the at least one portion of the TO may be either a first portion of the TO in the at least one SBFD symbol or a second portion of the TO in the at least one non-SBFD symbol. The terminal device 120 may transmit or receive data on one of the first portion of the TO or the second portion of the TO, and disable transmission or reception of data on the other one of the first portion of the TO or the second portion of the TO.

In some embodiments, the one of the first portion of the TO and the second portion of the TO is determined based on a preconfigured configuration. The preconfigured configuration may be hard coded in specification or configured by the network device 110, e.g. via RRC configuration. Alternatively or additionally, the one of the first portion of the TO and the second portion of the TO may has more symbols than the other one.

In some embodiments, in case that the TO may be for data repetition with a number of repetitions counted on available slot, the terminal device 120 may count on the slot as one repetition for the data repetition.

In some embodiments, the TO is a first TO, and the terminal device may perform the selection by splitting the first TO into a second TO in the at least one SBFD symbol and a third TO in the at least one non-SBFD symbol, and may transmit or receive data on the second TO and to transmit or receive data on the third TO.

In some embodiments, in case that the TO is for data repetition, the second TO and the third TO may use different redundancy versions (RVs) for rate matching. Alternatively or additionally, in case that a number of repetitions is counted on available slots, the terminal device 120 may count on the slot as two repetitions for the data repetition.

In some embodiments, in case that the TO is for transport block processing over multiple slots (TBoMS), the second TO and the third TO may have a same RV for rate matching.

In some embodiments, the terminal device 120 may determine whether the TO overlaps with any other UL or DL transmission. Based on determining that the TO overlaps with the other UL or DL transmission, the terminal device 120 may transmit or receive data on a non-overlapping portion of the TO that does not overlap with the other UL or DL transmission. The non-overlapping portion may be included in the at least one portion of the TO according to the selection.

In some embodiments, the terminal device 120 may disable, based on determining that the TO is invalid, transmission or reception of data on the TO determining that the TO is invalid. Alternatively or additionally, in case that the TO is for data repetition with number of repetitions is counted on available slots, the terminal device 120 may skip counting on the slot.

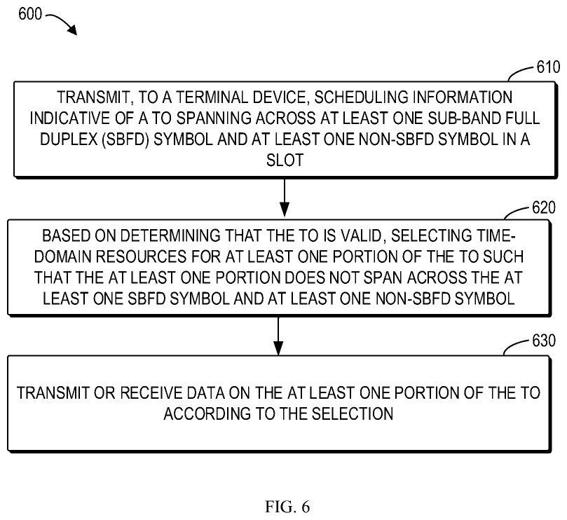

FIG. 6 illustrates another flowchart of an example method implemented at a network device in accordance with some embodiments of the present disclosure. For ease of understanding, the method 600 will be described from the perspective of the network device 110 with reference to FIG. 1A.

At block 610, the network device 110 transmits, to a terminal device 120, scheduling information indicative of a transmission occasion (TO) spanning across at least one sub-band full duplex (SBFD) symbol and at least one non-SBFD symbol in a slot. In some embodiments, the at least one SBFD symbol may include both of uplink (UL) frequency resources and downlink (DL) frequency resources. The at least one non-SBFD symbol may include either UL frequency resources or DL frequency resources. In some embodiments, the slot may comprise one or more gap symbols including guard time resources. The terminal device 120 may regard the one or more gap symbols as SBFD symbol(s) or non-SBFD symbol(s).

At block 620, based on determining that the TO is valid, the network device 110 selects time-domain resources for at least one portion of the TO such that the at least one portion does not span across the at least one SBFD symbol and at least one non-SBFD symbol.

At block 630, the network device 110 transmits or receives data on the at least one portion of the TO according to the selection.

In some embodiments, the at least one portion of the TO may be either a first portion of the TO in the at least one SBFD symbol or a second portion of the TO in the at least one non-SBFD symbol. The network device 110 may transmit or receive data on one of the first portion of the TO or the second portion of the TO, and disable transmission or reception of data on the other one of the first portion of the TO or the second portion of the TO.

In some embodiments, the one of the first portion of the TO and the second portion of the TO is determined based on a preconfigured configuration. The preconfigured configuration may be hard coded in specification or configured by the network device 110, e.g. via RRC configuration. Alternatively or additionally, the one of the first portion of the TO and the second portion of the TO may has more symbols than the other one.

In some embodiments, in case that the TO may be for data repetition with a number of repetitions counted on available slot, the network device 110 may count on the slot as one repetition for the data repetition.

In some embodiments, the TO is a first TO, and the terminal device may perform the selection by splitting the first TO into a second TO in the at least one SBFD symbol and a third TO in the at least one non-SBFD symbol, and may transmit or receive data on the second TO and to transmit or receive data on the third TO.

In some embodiments, in case that the TO is for data repetition, the second TO and the third TO may use different redundancy versions (RVs) for rate matching. Alternatively or additionally, in in case a number of repetitions is counted on available slots, the network device 110 may count on the slot as two repetitions for the data repetition.

In some embodiments, in case that the TO is for transport block processing over multiple slots (TBoMS), the second TO and the third TO may have a same RV for rate matching.

In some embodiments, the network device 110 may determine whether the TO overlaps with any other UL or DL transmission. Based on determining that the TO overlaps with the other UL or DL transmission, the network device 110 may transmit or receive data on a non-overlapping portion of the TO that does not overlap with the other UL or DL transmission. The non-overlapping portion may be included in the at least one portion of the TO according to the selection.

In some embodiments, the network device 110 may disable, based on determining that the TO is invalid, transmission or reception of data on the TO determining that the TO is invalid. Alternatively or additionally, in case that the TO is for data repetition with number of repetitions is counted on available slots, the network device 110 may skip counting on the slot.

In some embodiments, an apparatus capable of performing the method 500 (for example, the terminal device 120) may comprise means for performing the respective steps of the method 500. The means may be implemented in any suitable form. For example, the means may be implemented in a circuitry or software module.

In some example embodiments, the apparatus comprises: means for receiving, from a network device, scheduling information indicative of a transmission occasion (TO) spanning across at least one sub-band full duplex (SBFD) symbol and at least one non-SBFD symbol in a slot; means for selecting, based on determining that the TO is valid, time-domain resources for at least one portion of the TO such that the at least one portion does not span across the at least one SBFD symbol and at least one non-SBFD symbol; and means for transmitting or receiving data on the at least one portion of the TO according to the selection.

In some embodiments, the at least one portion of the TO is either a first portion of the TO in the at least one SBFD symbol or a second portion of the TO in the at least one non-SBFD symbol, and means for transmitting or receiving data on the at least one portion of the TO according to the selection may comprise means for transmitting or receiving data on one of the first portion of the TO or the second portion of the TO and means for disabling transmission or reception of data on the other one of the first portion of the TO or the second portion of the TO.

In some embodiments, the one of the first portion of the TO and the second portion of the TO may be determined based on a preconfigured configuration.

In some embodiments, the one of the first portion of the TO and the second portion of the TO may have more symbols than the other one.

In some embodiments, in case that the TO is for data repetition with a number of repetitions counted on available slots, the apparatus may comprise means for counting on the slot as one repetition for the data repetition.

In some embodiments, the TO may be a first TO, and means for selecting time-domain resources for at least one portion of the TO may comprise means for splitting the first TO into a second TO in the at least one SBFD symbol and a third TO in the at least one non-SBFD symbol, and means for transmitting or receiving data on the at least one portion of the TO according to the selection may comprise means for transmitting or receiving data on the second TO and to transmit or receive data on the third TO.

In some embodiments, in case that the TO is for data repetition, the second TO and the third TO may use different redundancy versions (RVs) for rate matching.

In some embodiments, apparatus may further comprise means for, in case that a number of repetitions is counted on available slots, counting on the slot as two repetitions for the data repetition.

In some embodiments, in case that the TO is for transport block processing over multiple slots (TBoMS), the second TO and the third TO have a same RV for rate matching.

In some embodiments, the at least one SBFD symbol may include both of uplink (UL) frequency resources and downlink (DL) frequency resources; and the at least one non-SBFD symbol may include either UL frequency resources or DL frequency resources.

In some embodiments, the apparatus may comprise means for regarding any gap symbol including guard time resources in the slot as a SBFD symbol or a non-SBFD symbol.

In some embodiments, the apparatus may comprise means for determining whether the TO overlaps with any other UL or DL transmission; and means for, based on determining that the TO overlaps with the other UL or DL transmission, transmitting or receiving data on a non-overlapping portion of the TO that does not overlap with the other UL or DL transmission, wherein the non-overlapping portion is included in the at least one portion of the TO according to the selection.

In some embodiments, the apparatus may comprise means for, based on determining that the TO is invalid, disabling transmission or reception of data on the TO.

In some embodiments, the apparatus may comprise means for, in case that the TO is for data repetition with number of repetitions is counted on available slots, skipping counting on the slot.

In some embodiments, the apparatus further comprises means for performing other steps in some embodiments of the method 500. In some embodiments, the means comprises at least one processor and at least one memory including computer program code, the at least one memory and computer program code configured to, with the at least one processor, cause the performance of the apparatus.

In some embodiments, an apparatus capable of performing the method 600 (for example, the network device 110) may comprise means for performing the respective steps of the method 600. The means may be implemented in any suitable form. For example, the means may be implemented in a circuitry or software module.

In some example embodiments, the apparatus comprises: means for transmitting, to a terminal device, scheduling information indicative of a transmission occasion (TO) spanning across at least one sub-band full duplex (SBFD) symbol and at least one non-SBFD symbol in a slot; means for selecting, based on determining that the TO is valid, time-domain resources for at least one portion of the TO such that the at least one portion does not span across the at least one SBFD symbol and at least one non-SBFD symbol; and means for transmitting or receiving data on the at least one portion of the TO according to the selection.

In some embodiments, the at least one portion of the TO is either a first portion of the TO in the at least one SBFD symbol or a second portion of the TO in the at least one non-SBFD symbol, and means for transmitting or receiving data on the at least one portion of the TO according to the selection may comprise means for transmitting or receiving data on one of the first portion of the TO or the second portion of the TO and means for disabling transmission or reception of data on the other one of the first portion of the TO or the second portion of the TO.

In some embodiments, the one of the first portion of the TO and the second portion of the TO may be determined based on a preconfigured configuration.

In some embodiments, the one of the first portion of the TO and the second portion of the TO may have more symbols than the other one.

In some embodiments, in case that the TO is for data repetition with a number of repetitions counted on available slots, the apparatus may comprise means for counting on the slot as one repetition for the data repetition.

In some embodiments, the TO may be a first TO, and means for selecting time-domain resources for at least one portion of the TO may comprise means for splitting the first TO into a second TO in the at least one SBFD symbol and a third TO in the at least one non-SBFD symbol, and means for transmitting or receiving data on the at least one portion of the TO according to the selection may comprise means for transmitting or receiving data on the second TO and to transmit or receive data on the third TO.

In some embodiments, in case that the TO is for data repetition, the second TO and the third TO may use different redundancy versions (RVs) for rate matching.

In some embodiments, apparatus may further comprise means for, in case that a number of repetitions is counted on available slots, counting on the slot as two repetitions for the data repetition.

In some embodiments, in case that the TO is for transport block processing over multiple slots (TBoMS), the second TO and the third TO have a same RV for rate matching.

In some embodiments, the at least one SBFD symbol may include both of uplink (UL) frequency resources and downlink (DL) frequency resources; and the at least one non-SBFD symbol may include either UL frequency resources or DL frequency resources.

In some embodiments, the apparatus may comprise means for regarding any gap symbol including guard time resources in the slot as a SBFD symbol or a non-SBFD symbol.

In some embodiments, the apparatus may comprise means for determining whether the TO overlaps with any other UL or DL transmission; and means for, based on determining that the TO overlaps with the other UL or DL transmission, transmitting or receiving data on a non-overlapping portion of the TO that does not overlap with the other UL or DL transmission, wherein the non-overlapping portion is included in the at least one portion of the TO according to the selection.

In some embodiments, the apparatus may comprise means for, based on determining that the TO is invalid, disabling transmission or reception of data on the TO.

In some embodiments, the apparatus may comprise means for, in case that the TO is for data repetition with number of repetitions is counted on available slots, skipping counting on the slot.

In some embodiments, the apparatus further comprises means for performing other steps in some embodiments of the method 600. In some embodiments, the means comprises at least one processor and at least one memory including computer program code, the at least one memory and computer program code configured to, with the at least one processor, cause the performance of the apparatus.

FIG. 7 illustrates a simplified block diagram of a device 700 that is suitable for implementing some example embodiments of the present disclosure. The device 700 may be provided to implement a communication device, for example, the network device 110 or the terminal device 120 as shown in FIG. 1A. As shown, the device 700 includes one or more processors 5710, one or more memories 720 coupled to the processor 710, and one or more communication modules 740 coupled to the processor 710.

The communication module 740 is for bidirectional communications. The communication module 740 has at least one antenna to facilitate communication. The communication interface may represent any interface that is necessary for communication with other network elements.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the ROM 724. The processor 710 may perform any suitable actions and processing by loading the program 730 into the RAM 722.

The embodiments of the present disclosure may be implemented by means of the program 730 so that the device 700 may perform any process of the disclosure as discussed with reference to FIGS. 4 and 5. The embodiments of the present disclosure may also be implemented by hardware or by a combination of software and hardware.

In some example embodiments, the program 730 may be tangibly contained in a computer-readable medium which may be included in the device 700 (such as in the memory 720) or other storage devices that are accessible by the device 700. The device 700 may load the program 730 from the computer-readable medium to the RAM 722 for execution. The computer-readable medium may include any types of tangible non-volatile storage, such as ROM, EPROM, a flash memory, a hard disk, CD, DVD, and the like.

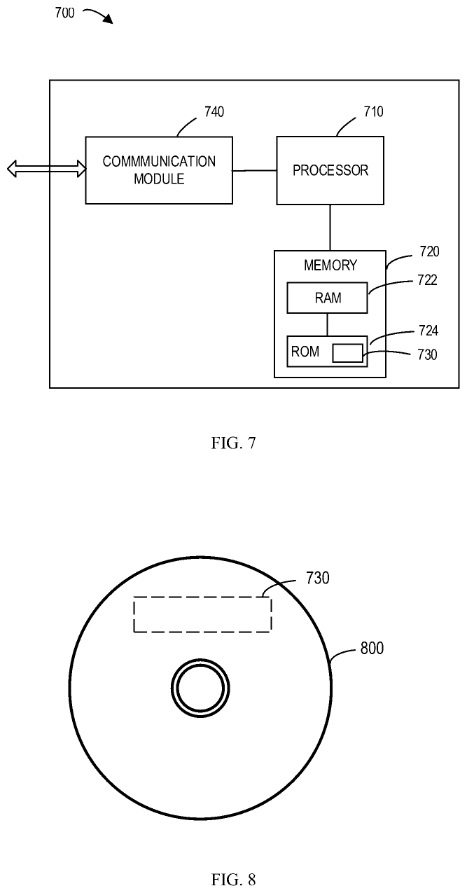

FIG. 8 illustrates a block diagram of an example of a computer-readable medium 600 in accordance with some example embodiments of the present disclosure. The computer-readable medium 800 has the program 730 stored thereon. It is noted that although the computer-readable medium 800 is depicted in form of CD or DVD in FIG. 8, the computer-readable medium 800 may be in any other form suitable for carry or hold the program 730.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer-readable storage medium. The computer program product includes computer-executable instructions, such as those included in program modules, being executed in a device on a target real or virtual processor, to carry out the method 500 or 600 as described above with reference to FIG. 5 or 6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer-readable medium, and the like.

The computer-readable medium may be a computer-readable signal medium or a computer-readable storage medium. A computer-readable medium may include but not limited to an electronic, magnetic, optical, electromagnetic, infrared, or semiconductor system, apparatus, or device, or any suitable combination of the foregoing. More specific examples of the computer-readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A terminal device comprising:
at least one processor; and
at least one memory storing instructions that, when executed by the at least one processor, cause the terminal device at least to:
receive, from a network device, scheduling information indicative of a transmission occasion (TO) spanning across at least one sub-band full duplex (SBFD) symbol and at least one non-SBFD symbol in a slot;
based on determining that the TO is valid, select time-domain resources for at least one portion of the TO such that the at least one portion does not span across the at least one SBFD symbol and at least one non-SBFD symbol; and
transmit data on the at least one portion of the TO according to the selection.

2. The terminal device of claim 1, wherein the at least one portion of the TO is either a first portion of the TO in the at least one SBFD symbol or a second portion of the TO in the at least one non-SBFD symbol and the terminal device is caused to:
transmit data on one of the first portion of the TO or the second portion of the TO; and
disable transmission of data on the other one of the first portion of the TO or the second portion of the TO.

3. The terminal device of claim 2, wherein the one of the first portion of the TO and the second portion of the TO is determined based on a preconfigured configuration.

4. The terminal device of claim 2, wherein the one of the first portion of the TO and the second portion of the TO has more symbols than the other one.

5. The terminal device of claim 2, wherein in case that the TO is for data repetition with a number of repetitions counted on available slots, the terminal device is further caused to:
count on the slot as one repetition for the data repetition.

6. The terminal device of claim 1, wherein the TO is a first TO, and the terminal device is caused to:
perform the selection by splitting the first TO into a second TO in the at least one SBFD symbol and a third TO in the at least one non-SBFD symbol; and
transmit data on the second TO and to transmit data on the third TO.

7. The terminal device of claim 6, wherein in case that the TO is for data repetition, the second TO and the third TO use different redundancy versions (RVs) for rate matching.

8. The terminal device of claim 7, wherein the terminal device is further caused to:
in case that a number of repetitions is counted on available slots, count on the slot as two repetitions for the data repetition.

9. The terminal device of claim 6, wherein in case that the TO is for transport block processing over multiple slots (TBoMS), the second TO and the third TO have a same RV for rate matching.

10. The terminal device of claim 1, wherein:
the at least one SBFD symbol includes both of uplink (UL) frequency resources and downlink (DL) frequency resources; and
the at least one non-SBFD symbol includes either UL frequency resources or DL frequency resources.

11. The terminal device of claim 10, wherein the terminal device is caused to regard any gap symbol including guard time resources in the slot as a SBFD symbol or a non-SBFD symbol.

12. The terminal device of claim 1, wherein the terminal device is further caused to:
determine whether the TO overlaps with any other UL or DL transmission; and
based on determining that the TO overlaps with the other UL or DL transmission, transmit data on a non-overlapping portion of the TO that does not overlap with the other UL or DL transmission, wherein the non-overlapping portion is included in the at least one portion of the TO according to the selection.

13. The terminal device of claim 1, wherein the terminal device is further caused to:
based on determining that the TO is invalid, disable transmission of data on the TO.

14. The terminal device of claim 13, wherein the terminal device is further cause to:
in case that the TO is for data repetition with number of repetitions is counted on available slots, skip counting on the slot.

15. A network device comprising:
at least one processor; and
at least one memory storing instructions that, when executed by the at least one processor, cause the network device at least to:
transmit, to a terminal device, scheduling information indicative of a transmission occasion (TO) spanning across at least one sub-band full duplex (SBFD) symbol and at least one non-SBFD symbol in a slot;
based on determining that the TO is valid, select time-domain resources for at least one portion of the TO such that the at least one portion does not span across the at least one SBFD symbol and at least one non-SBFD symbol; and
receive data on the at least one portion of the TO according to the selection.

16. The network device of claim 15, wherein the at least one portion of the TO is either a first portion of the TO in the at least one SBFD symbol or a second portion of the TO in the at least one non-SBFD symbol and the network device is caused to:
receive data on one of the first portion of the TO or the second portion of the TO; and
disable reception of data on the other one of the first portion of the TO or the second portion of the TO.

17-19. (canceled)

20. The network device of claim 15, wherein the TO is a first TO, and the network device is caused to:
perform the selection by splitting the first TO into a second TO in the at least one SBFD symbol and a third TO in the at least one non-SBFD symbol; and
receive data on the second TO and to receive data on the third TO.

21-25. (canceled)

26. The network device of claim 15, wherein the network device is further caused to:
determine whether the TO overlaps with any other UL or DL transmission; and
based on determining that the TO overlaps with the other UL or DL transmission, er-receive data on a non-overlapping portion of the TO that does not overlap with the other UL or DL transmission, wherein the non-overlapping portion is included in the at least one portion of the TO according to the selection.

27. The network device of claim 15, wherein the network device is further caused to:
based on determining that the TO is invalid, disable reception of data on the TO.

28. (canceled)

29. A method comprising:
receiving, from a network device, scheduling information indicative of a transmission occasion (TO) spanning across at least one sub-band full duplex (SBFD) symbol and at least one non-SBFD symbol in a slot;
selecting, based on determining that the TO is valid, time-domain resources for at least one portion of the TO such that the at least one portion does not span across the at least one SBFD symbol and at least one non-SBFD symbol; and
transmitting data on the at least one portion of the TO according to the selection.

30-34. (canceled)
